(19) United States
(12) Patent Application Publication
(10) Pub. No.: US 2020/0158317 A1
(43) Pub. Date: May 21, 2020

(54) Preset Movable Yoke

(71) Applicant: TMB, Inc, San Fernando, CA (US)

(72) Inventor: Colin Waters, San Fernando, CA (US)

(21) Appl. No.: 16/191,758

(22) Filed: Nov. 15, 2018

(51) Int. Cl. F21V 21/30

(52) U.S. Cl. CPC F21V 21/30; F21Y 2103/10

(57) ABSTRACT

A preset yoke is movable when loosened. At certain preset angle values, the user feels resistance and a click exactly at the angle value. This facilitates maintaining the yoke into angles of the preset. The presets are set at commonly used angles, e.g., 0 degrees, 45 degrees and 90 degrees.

This application claims priority from provisional application No. 62/585,519, filed Nov. 15, 2017, the entire contents of which are herewith incorporated by reference.

### BACKGROUND

Stage lighting instruments are used in stage lighting to illuminate theatrical productions, concert or performance in venues. A typical stage lighting instrument has a housing which holds the illuminating lamp and prevents light from the lamp from spilling in unwanted directions.

The housing is mounted on a U-shaped yoke, which is fixed at two points to the sides of the housing. The housing can rotate on those two points, providing a tilt axis of rotation.

The base of the yoke has typically a single bolt around the yoke which the yoke can be rotated, thus rotating the housing in the panning direction from side to side.

### SUMMARY

The present application describes a special yoke called a preset yoke. The preset yoke can be fitted onto any of a number of different fixtures. The fixture can be moved on the yoke, after the yoke has been loosened, over a full range of motion. However, at designated preset angles, the yoke provides a special definite resistance and a tactile click, allowing the user to easily place the light into specified angles before tightening the yoke.

### BRIEF DESCRIPTION OF THE DRAWINGS

The drawings show aspects of the invention, where:

FIGS. 1A and 1B show a movable light with a preset yoke;

FIG. 2 shows the preset yoke in a 1^{st} position;

FIG. 3 shows the preset yoke in a 2^{nd} hundred 20° position;

FIG. 4 shows the preset yoke in the 3^{rd} position;

FIG. 5 shows the yoke set in a side facing position;

FIG. 6 shows the preset yoke in a 45° position; and

FIG. 7 shows the preset yoke in a straight up and down position.

### DETAILED DESCRIPTION

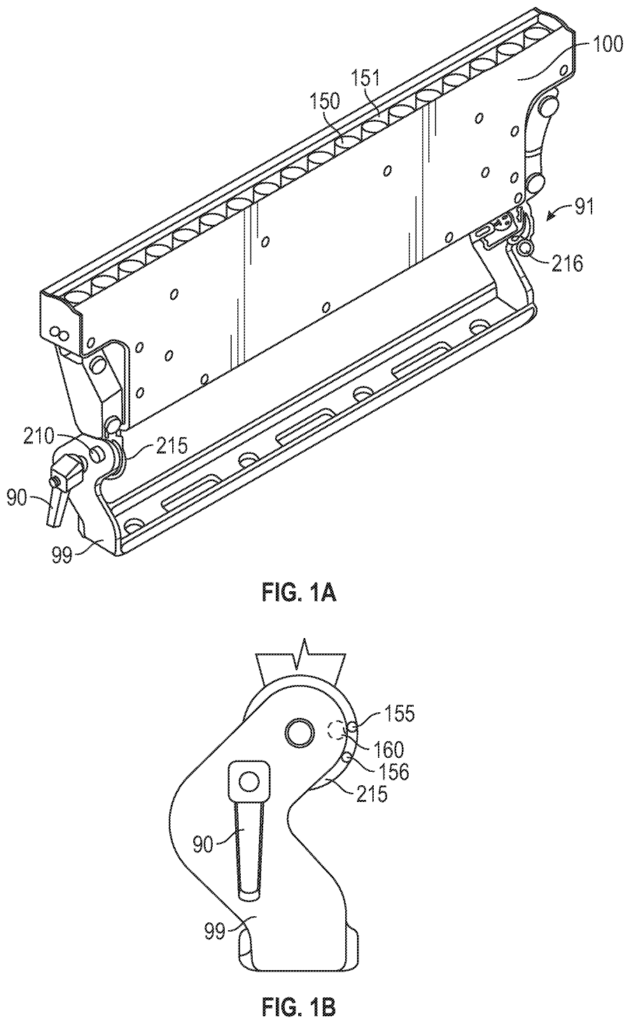

An exemplary lighting fixture is shown in FIG. 1 which uses the techniques according to the present application. The lighting fixture 100 is shown as the TMB Flare Q+“Rayzr™” fixture.

FIG. 1 shows the fixture 100 attached to the yoke 99. The yoke itself has tightening mechanisms 90 and 91. These mechanisms are tightened and loosened. When tightened, the fixture is maintained in place at the pointing position of the yoke where the fixture has been last located prior to tighening. However, when loosened, the fixture can be freely moved on the yoke, over its entire range of motion.

The specific yoke shown in FIG. 1 has a range of motion that is limited by the specific locations of the surfaces on the yoke, with an extreme to the left in FIG. 3 being at 120° and to the right in FIG. 4 being at −55° relative to the support. The fixture is capable of a range of motion between those two values.

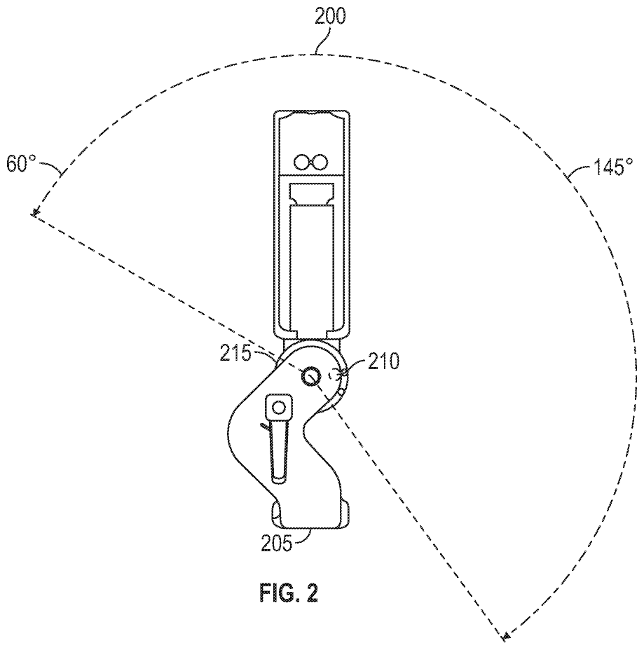

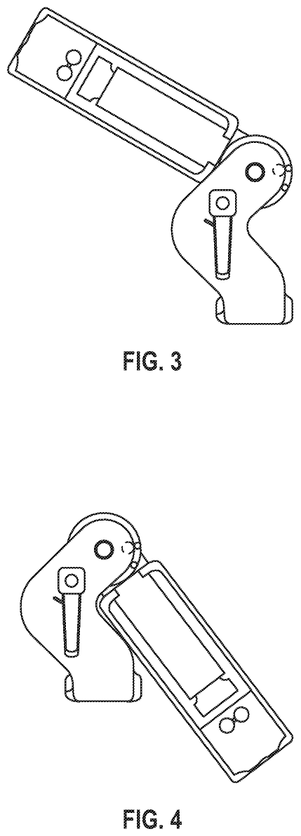

FIG. 2 shows the fixture located into the 0° position, that is to say that the fixture output 200 is pointing at 0° from the location of mounting of the yoke 205.

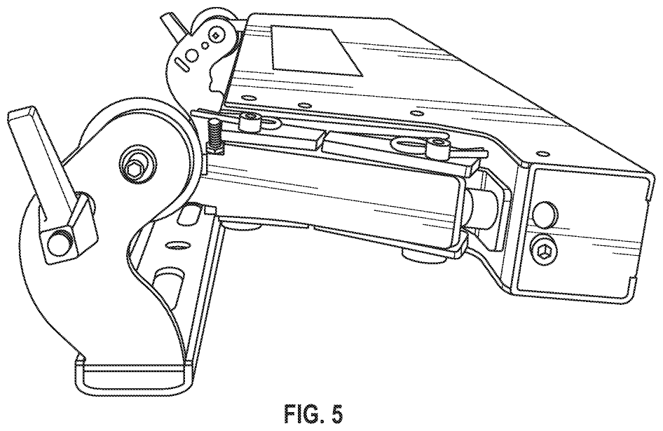

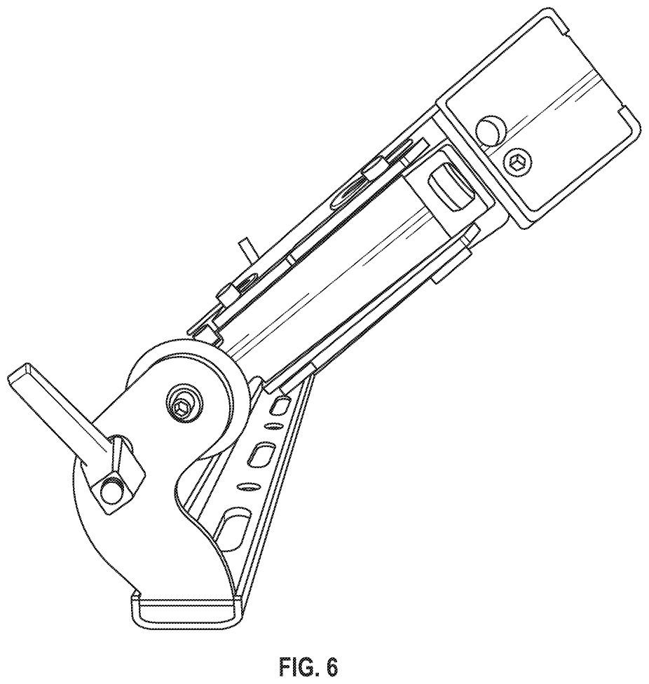

When the mechanisms 90 and 91 are loosened, the device can be moved, and is preferably there is a click mechanism that causes an audible and tactile click at specified angular locations. FIG. 5 illustrates the first preset location, where the lighting head is at 90° relative to the support. Of course, the device can also be at the opposite direction relative to the support, that is facing in the exact opposite direction from the FIG. 5 picture.

In a similar way, the device is shown at its second preset of 45° in FIG. 6, but can also be at the opposite 135° where there is another preset.

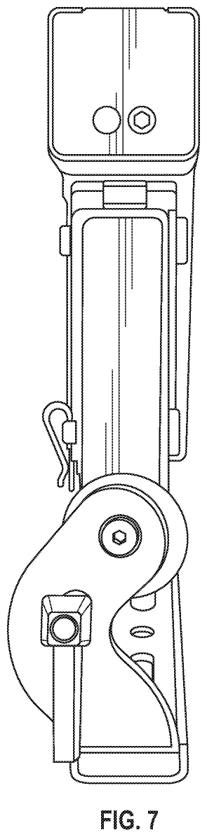

Yet another preset is located at 0°, as shown in FIG. 7.

The head 100 can be moved by loosening the knobs 90, 91, allowing that light head 100 to pivot relative to the yoke 99. In an embodiment, the light head 100 is a linear head, having a plurality of lighting element 150, 151, arranged in a row, and displaying out of the head. The light head can be moved back and forth.

The light head is mounted on disk shaped light holding elements 215, 216, one at each end of the head. The disc shaped light holding elements such as 215 include a hole therein, which holds the element to via a hinging pin 210 to the yoke structure 99. When the knob 90 is loosened, the head 100 can hinge on the hinge pins 210.

However, a plurality of tactile preset structure, is located either on the disc shaped holder 215, or on the inside surface of the light holder 99, or preferably on both. The structure may be a location, for example, where there is a protuberance or projection 155 on the surface of the disc shaped holder 215 that faces towards the yoke. Similarly, there is a protuberance-mating-structure 160 on the inner surface of the yoke 99. This protuberance mating structure can be a slight indentation, or can be a hollow, disc-shaped surface which extends slightly above the surface of the yoke.

When the knob 90 is loosened, it leaves enough room for the disc shaped holder 215 to rotate relative to the inside of the yoke. However, since the protuberance 155 extends a little closer to the inside surface of the yoke 99, the mating between the protuberance 155 and the mating structure 160 will cause an audible and tactile sound and reaction whenever the protuberance meets the mating structure.

There may be other protuberances at other locations, for example the protuberance 156 may cause a tactile reaction when the light head is tilted at that location. When loosened, the head 100 moves freely on the hinges, but still causes a tactile sensation when reaching the preset locations.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A lighting device comprising:
a lighting head including a lighting structure therein;
a yoke, which holds the lighting head;
a hinging member, between the yoke and the lighting head; and
a structure which causes a tactile click to occur at each of a plurality of different preset locations on the hinging member, representing the plurality of preset angular relationships between the lighting head and the yoke,
a tightening mechanism, which tightens between the lighting head and yoke, and prevents the lighting head from moving relative to the yoke.

2. The device as in claim 1, wherein the lighting head is and elongated lighting head, including a plurality of individual lighting elements linearly arranged along the lighting head.

3. The device as in claim 1, wherein the lighting head is mounted on a disk shaped lighting holder, that includes a hinge part that hinges to the yoke.

4. The device as in claim 3, wherein the disc shaped lighting holder includes multiple different protuberances, at multiple different preset locations of the lighting device, each of the protuberances mating with a spot on the inside surface of the yoke, to cause the tactile click when the protuberance mates with the spot.

5. The device as in claim 4, wherein the spot comprises a location on an inside surface of the yoke which faces to the disc shaped lighting holder where a disk shaped projection extends above a surface of the yoke, the disc shaped projection sized to fit around the protuberances on the disc shaped lighting holder of the lighting head.

6. The device as in claim 5, wherein the protuberances are located at locations which cause the tactile click at each of 0, 90° and 45°.
